(19) United States
(12) Patent Application Publication
(10) Pub. No.: US 2009/0217067 A1
(43) Pub. Date: Aug. 27, 2009

(54) Systems and Methods for Reducing Power Consumption in a Redundant Storage Array

(75) Inventors: Ramesh Radhakrishnan, Austin, TX (US); Arun Rajan, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 12/038,234

(22) Filed: Feb. 27, 2008

(51) Int. Cl. G06F 1/32; G06F 12/16

(52) U.S. Cl. 713/320; 711/114; 711/E12.103

(57) ABSTRACT

A method for reducing power consumption in a mirrored disk array including first disk resources mirrored with second disk resources is provided. A write request to write particular data to the mirrored disk array is received. In response to receiving the write request, the first disk resources are spun to write the particular data to the first disk resources, and the particular data is stored to a cache memory without spinning the second disk resources. Subsequent to storing the particular data to the first disk resources and storing the particular data to the cache memory, the second disk resources are spun to write the particular data from the cache memory to the second disk resources.

### TECHNICAL FIELD

The present disclosure relates in general to data storage, and more particularly to systems and methods for reducing power consumption in a redundant storage array.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput and/or capacity. In operation, one or more storage resources disposed in an array of storage resources may appear to an operating system as a single logical storage unit or “logical unit.” Implementations of storage resource arrays can range from a few storage resources disposed in a server chassis, to hundreds of storage resources disposed in one or more separate storage enclosures.

RAID arrays typically provide data redundancy by “mirroring,” in which an exact copy of data on one logical unit is copied on more than one logical units (e.g., disks). In addition, in some RAID systems, data may be split and stored across multiple disks, which is referred to as “striping.”

Basic mirroring can speed up reading data as an information handling system can read different data from both disks, but it may be slow for writing if the configuration requires that both disks must confirm that the data is correctly written. Striping is often used for increased performance, as it allows sequences of data to be read from multiple disks at the same time (i.e., in parallel). Modern disk arrays typically allow a user to select the desired RAID configuration.

Different RAID configuration mirroring, striping, or both mirroring and striping of data. For example, RAID 0 provides data striping, but not data mirroring. Data to be stored is broken into fragments, where the number of fragments is dictated by the number of disks in the drive. The fragments are written to the multiple disks simultaneously on the same sector of each respective disk. This allows smaller sections of the entire chunk of data to be read off the drive in parallel, giving this type of arrangement large bandwidth. However, RAID 0 provides no redundancy or fault tolerance, as any disk failure destroys the array.

In contrast, RAID 1 provides data mirroring without striping. A RAID 1 configuration typically includes two disks of similar size and speed. Data written to one disk is simultaneously copied to the second disk, which provides redundancy and thus fault tolerance from disk errors and single disk failure.

RAID 01 and RAID 10 are popular “multiple” or “nested” RAID levels, which combined striping and mirroring to yield large arrays with relatively high performance and superior fault tolerance. RAID 01 essentially consists of striping, then mirroring of data, or in other words, RAID 01 is a mirrored configuration of two striped data sets. In contrast, RAID 10 essentially consists of mirroring, then striping of data, or in other words, RAID 10 is a stripe across a number of mirrored disk sets.

For any storage system, energy efficiency has become an important issue due, for example, to power budgets often required by data-center storage systems. RAID storage arrays provide a particular challenge for power management, as such arrays typically provide power to more resources than traditional storage systems.

### SUMMARY

In accordance with the teachings of the present disclosure, energy consumption associated with certain types of storage arrays may be reduced.

In accordance with one embodiment of the present disclosure, a method for reducing power consumption in a mirrored disk array including first disk resources mirrored with second disk resources is provided. A write request to write particular data to the mirrored disk array is received. In response to receiving the write request, the first disk resources are spun to write the particular data to the first disk resources, and the particular data is stored to a cache memory without spinning the second disk resources. Subsequent to storing the particular data to the first disk resources and storing the particular data to the cache memory, the second disk resources are spun to write the particular data from the cache memory to the second disk resources.

In accordance with another embodiment of the present disclosure, an information handling system configured for reducing power consumption in a mirrored disk array includes a mirrored disk array including first disk resources mirrored with second disk resources, and a storage controller. The storage controller may be configured to receive a write request to write particular data to the mirrored disk array. In response to receiving the write request, the storage controller may spin the first disk resources to write the particular data to the first disk resources; store the particular data to a cache memory without spinning the second disk resources; and subsequent to storing the particular data to the first disk resources and storing the particular data to the cache memory, spin the second disk resources to write the particular data from the cache memory to the second disk resources.

In accordance with another embodiment of the present disclosure, a method for reducing power consumption in a mirrored disk array including first disk resources mirrored with second disk resources is provided. A read or write request is received at the mirrored disk array. In response to receiving the read or write request, the first disk resources are spun to process the read or write request, and the second disk resources are not spun during processing of the read or write request by the first disk resources.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system for reducing power consumption of a storage array, in accordance with the present disclosure;

FIG. 2 illustrates an example system for managing the power consumption of a storage array of the system of FIG. 1 configured as a RAID 10 array, according to certain embodiments of the present disclosure;

FIG. 3 illustrates another example system for managing the power consumption of a storage array of the system of FIG. 1 configured as a RAID 10 array, according to certain embodiments of the present disclosure;

FIG. 4 illustrates an example method of configuring an energy efficient mirrored RAID configuration for a storage array, according to certain embodiments of the present disclosure; and

FIG. 5 illustrates an example method of operating an energy efficient storage array, according to certain embodiments of the present disclosure.

### DETAILED DESCRIPTION

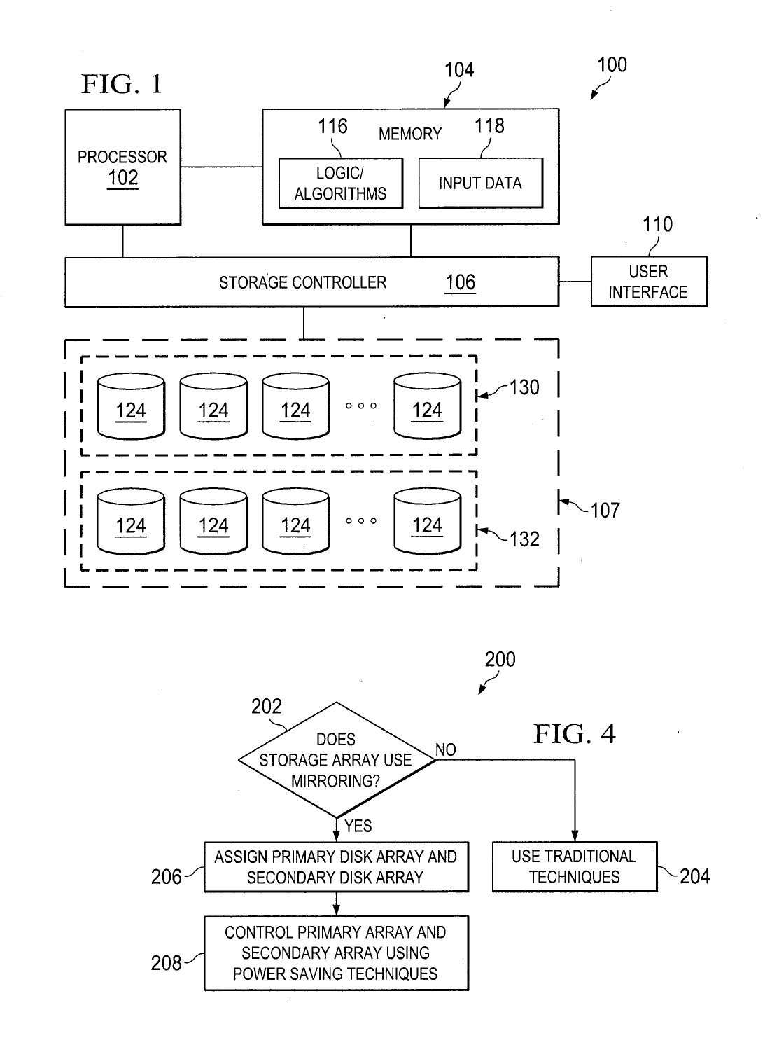

Preferred embodiments and their advantages are best understood by reference to FIGS. 1-5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

As discussed above, an information handling system may include or may be coupled via a storage network to an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 1 illustrates a block diagram of an example information handling system 100 for reducing power consumption of a storage array, in accordance with the present disclosure. As depicted in FIG. 1, information handling system 100 may comprise a processor 102, a memory 104 communicatively coupled to processor 102, a storage controller 106 communicatively coupled to processor 102, a user interface 110, and a storage array 107 communicatively coupled to storage controller 106. In some embodiments, information handling system 100 may comprise a server or server system.

Processor 102 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104 and/or other components of information handling system 100. For example, as discussed below, processor 102 may execute one or more algorithms stored in memory 114 associated with storage controller 106. In the same or alternative embodiments, processor 102 may communicate data to and/or from storage array 107 via storage controller 106.

Memory 104 may be communicatively coupled to processor 102 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off.

In some embodiments, memory 104 may store algorithms or other logic 116 for controlling storage array 107 in order to manage power consumption by storage array 107. In addition, memory 104 may store various input data 118 used by storage controller 106 for controlling storage array 107 in order to manage power consumption by storage array 107. Input data 118 may include, for example, user selections or other input from a user via user interface 110, e.g., regarding power management or performance preferences (as discussed below in greater detail).

Storage controller 106 may be communicatively coupled to processor 102 and/or memory 104 and include any system, apparatus, or device operable to manage the communication of data between storage array 107 and one or more of processor 102 and memory 104. As discussed below in greater detail, storage controller 106 may be configured to control storage array 107 in order to manage power consumption by storage array 107. In some embodiments, storage controller 106 may execute one or more algorithms or other logic 116 to provide such functionality. In addition, in some embodiments, storage controller 106 may provide other functionality known in the art, including, for example, disk aggregation and redundancy (e.g., RAID), input/output (I/O) routing, and/or error detection and recovery.

Storage controller 106 may be implemented using hardware, software, or any combination thereof. Storage controller 106 may cooperate with processor 102 and/or memory 104 in any suitable manner to provide the various functionality of storage controller 106. Thus, storage controller 106 may be communicatively coupled to processor 102 and/or memory 104 in any suitable manner. In some embodiments, processor 102 and/or memory 104 may be integrated with, or included in, storage controller 106. In other embodiments, processor 102 and/or memory 104 may be separate from, but communicatively coupled to, storage controller 106.

User interface 110 may include any systems or devices for allowing a user to interact with system 100. For example, user interface 110 may include a display device, a graphic user interface, a keyboard, a pointing device (e.g., a mouse), any or any other user interface devices known in the art. As discussed below, in some embodiments, user interface 110 may provide an interface allowing the user to provide various input and/or selections regarding the operation of system 100. For example, user interface 110 may provide an interface allowing the user to make selections or provide other input regarding (a) a desired RAID level or configuration for storage array 107 and/or (b) power management or performance options or preferences for storage array 107.

Algorithms or other logic 116 may be stored in memory 104 or other computer-readable media, and may be operable, when executed by processor 102 or other processing device, to perform any of the functions discussed herein for controlling storage array 107 in order to manage power consumption by storage array 107 and/or any other functions associated with storage controller 106. Algorithms or other logic 116 may include software, firmware, and/or any other encoded logic.

Storage array 107 may comprise any number and/or type of storage resources, and may be communicatively coupled to processor 102 and/or memory 104 via storage controller 106. Storage resources may include hard disk drives, magnetic tape libraries, optical disk drives, magneto-optical disk drives, compact disk drives, compact disk arrays, disk array controllers, and/or any computer-readable medium operable to store data. In operation, storage resources in storage array 107 may be divided into logical storage units or LUNs. Each logical storage unit may comprise, for example, a single storage resource (e.g., a disk drive), multiple storage resources (e.g., multiple disk drives), a portion of a single storage resource (e.g., a portion of a disk drive), or portions of multiple storage resources (e.g., portions of two disk drives), as is known in the art.

In the example embodiments discussed below, each logical storage unit is a single disk drive 124. However, the concepts discussed herein apply similarly to any other types of storage resources and/or logical storage units.

Each disk drive 124 is connected either directly or indirectly to storage controller 106 by one or more connections. In some embodiments, disk drive 124 are located in enclosures such as racks, cabinets, or chasses that provided connections to storage controller 106.

Storage array 107 may be implemented as a RAID array of drives 124. In some embodiments, the storage array 107 may include mirroring and/or striping of data stored on drives 124. As examples only, storage array 107 may be implemented as a RAID 1, RAID 01, RAID 10, or RAID 51 array.

In the example embodiment shown in FIG. 1, storage array 107 including a first set of drives 124, indicated at 130, and a second set of drives 124, indicated at 132. The second set of drives 132 provides a mirrored copy of the first set of drives 130, such that a copy of data stored in drives 130 is stored in drives 132. Each set of drives 130, 132 may include one drive (e.g., RAID 0) or multiple drives (e.g., RAID 01, RAID 10, or RAID 51). In some embodiments with multiple drives in each set of drives 130, 132, data may be striped across the multiple drives in each set.

In operation, storage controller 106 may control the operation of drives 124 within array 107, including, e.g., spinning-up and spinning-down various drives 124 at particular times, and controlling the speed at which the various drives 124 are operated.

In some embodiments, storage controller 106 may control the operation of first set of drives 130, which may be designated as primary drives 130, differently than the operation of second set of drives 132, which may be designated as secondary drives 132. For example, secondary drives 132 may be operated in a lower power mode than primary drives 130 at particular times. As defined herein, operating drives 132 in a “lower power mode” may include, e.g., spinning-down drives 132, operating drives 132 at a lower speed, placing drives 132 in a low-power idle mode, turning off drives 132, not supplying power to drives 132, or any other mode of operation of drives 132 that may reduce the power consumption of drives 132.

Some example situations in which drives 132 may be operated in a lower power mode as compared to drives 130 include:

(1) In some embodiments, data read requests may be directed only to primary drives 130, and not to secondary drives 132. Thus, secondary drives 132 may be operated in a lower power mode while primary drives 130 process incoming read requests.

(2) In some embodiments, secondary drives 132 may be operated at a lower speed for processing data write requests, as compared to primary drives 130.

(3) In some embodiments, a power management policy defined for operating secondary drives 132 in a lower power mode may be more aggressive than a defined policy for operating primary drives 130 in a lower power mode. The defined policy for each set of drives 130, 132 may include one or more thresholds for determining when to operate the respective drives 130, 132 in a lower power mode. One or more thresholds defined for secondary drives 130 may be more aggressive than corresponding thresholds defined for primary drives 132. For example, a power management policy for primary drives 130 may specify that primary drives 130 may be operated in a lower power mode after x minutes of inactivity, while a corresponding power management policy for primary drives 130 may specify that secondary drives 132 may be operated in a lower power mode after y minutes of inactivity, where y<x.

(4) In some embodiments, data write requests may be performed initially by primary drives 130, but not by secondary drives 132. For example, data in an incoming data write request may be written to disk on primary drives 130, but may be cached for secondary drives 132, and then later written to disk on secondary drives 132. Caching the data intended for secondary drives 132 may include storing the data in (a) one or more cache memory (e.g., volatile memory) portions of secondary drives 132, or (b) one or more drives (e.g., non-volatile memory) separate from primary drives 130 and secondary drives 132 that are used as a data cache. The cached data may be subsequently written to disk on secondary drives 132 upon some triggering event, e.g., a predefined time period, the cache reaching a predefined fill level threshold, or the number of data writes to the cache reaching threshold. In some embodiments, secondary drives 132 may be run at a lower speed or power level for writing the cached data to disk on secondary drives 132 as compared with the operation of primary drives 130 during the original writing of the data to disk on primary drives 130.

(5) In some embodiments, data write requests may be cached by both primary drives 130 and secondary drives 132. For example, data in an incoming data write request may be stored in cache memory (e.g., volatile memory) portions of both primary drives 130 and secondary drives 132, and then later written to disk on both primary drives 130 and secondary drives 132.

Any one of these techniques (1)-(5), any combination of techniques (1)-(5), and/or any other suitable techniques for managing power consumption of storage array 107 may be implemented by storage controller 106, according to various embodiments. For example, such techniques may be embodied in one or more algorithms 116 accessible to storage controller 106 and executable by processor 102.

In some embodiments, controller 106 may allow a user to select or otherwise provide input (e.g., via interface 110) regarding one or more of techniques (1)-(5) and/or any other suitable techniques for managing power consumption of storage array 107. For example, a user may select one or more of techniques (1)-(5) to be implemented by controller 106 and/or various thresholds for placing drives 130 and/or 132 in a lower power mode (e.g., an inactive time threshold for spinning down secondary drives 132). In other embodiments, controller 106 may automatically determine which techniques to implement for a particular configuration or situation based on data accessible to controller 106.

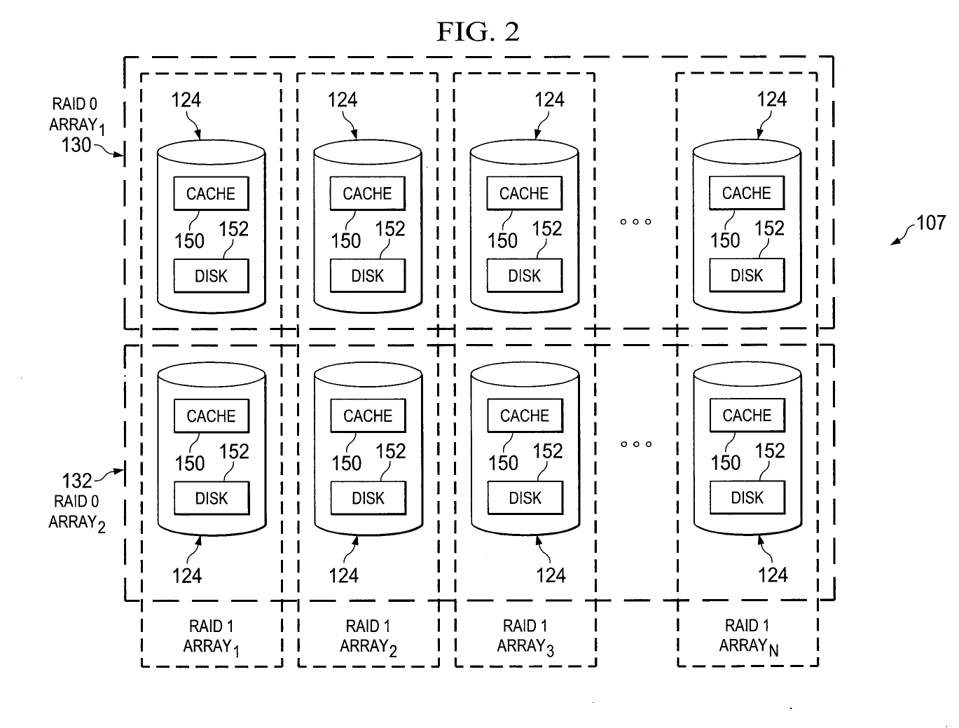

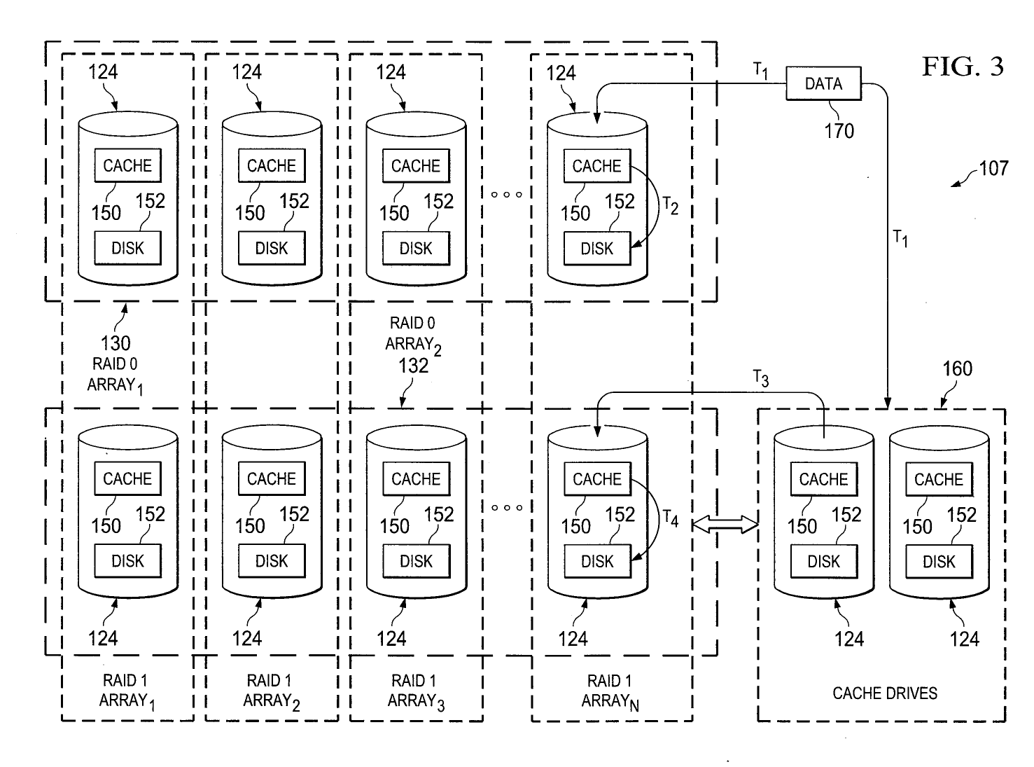

Example embodiments of the various techniques (1)-(5) are discussed below regarding FIGS. 2-3 with reference to an example RAID 10 configuration. However, it should be understood that such techniques may be similarly applied to various other RAID or other redundant storage configurations. For example, other embodiments include RAID 0, RAID 01, and RAID 51 storage arrays 107.

FIG. 2 illustrates an example system for managing the power consumption of storage array 107 configured as a RAID 10 array, according to certain embodiments of the present disclosure.

In the example embodiment shown in FIG. 2, storage array 107 is a RAID 10 array including a first set of primary drives 130, indicated as RAID 0 Array₁, and a second set of secondary drives 132, indicated as RAID 0 Array₂. Each primary drive 130 is mirrored to a corresponding secondary drive 132, to define RAID 1 Array₁ through RAID 1 Array_{N}. Each primary drive 130 and secondary drive 132 includes a cache memory portion 150 (e.g., volatile memory) and a disk portion 152 (e.g., non-volatile memory).

In this example embodiment, data read requests intended for array 107 are directed only to primary drives 130, and not to secondary drives 132. Thus, secondary drives 132 may be spun down or otherwise operated in a lower power mode while primary drives 130 process incoming read requests.

In addition, for processing data write requests, the data may be written (a) to disk portion 152 of primary drives 130 and (b) to cache portion 150 of secondary drives 132. The cached data may be subsequently written to disk portion 152 of secondary drives 132 (i.e., flushed) upon some triggering event, e.g., a predefined time period, the cache reaching a predefined fill level threshold, or the number of data writes to the cache reaching threshold. Secondary drives 132 may be run at a lower speed or power level when the data is eventually written to disk portion 152 from cache portion 150, as compared with the operation of primary drives 130 during the original writing of the data to primary drives 130.

FIG. 3 illustrates another example system for managing the power consumption of storage array 107 configured as a RAID 10 array, according to certain embodiments of the present disclosure.

As in the example embodiment shown in FIG. 2, in the example embodiment shown in FIG. 3, storage array 107 is a RAID 10 array including a first set of primary drives 130, indicated as RAID 0 Array₁, and a second set of secondary drives 132, indicated as RAID 0 Array₂. Each primary drive 130 is mirrored to a corresponding secondary drive 132, to define RAID 1 Array₁ through RAID 1 Array_{N}. Each primary drive 130 and secondary drive 132 includes a cache memory portion 150 (e.g., volatile memory) and a disk portion 152 (e.g., non-volatile memory).

In this example embodiment, data read requests intended for array 107 are directed only to primary drives 130, and not to secondary drives 132. Thus, secondary drives 132 may be spun down or otherwise operated in a lower power mode while primary drives 130 process incoming read requests.

In addition, for processing data write requests, the data may be written (a) to disk portion 152 of primary drives 130 and (b) to one or more cache drives 160 separate from primary drives 130 and secondary drives 132. The cached data may be subsequently written to secondary drives 132 upon some triggering event, e.g., a predefined time period, the cache reaching a predefined fill level threshold, or the number of data writes to the cache reaching threshold. Secondary drives 132 may be run at a lower speed or power level when the data is eventually written to disk portion 152 from cache drives 160, as compared with the operation of primary drives 130 during the original writing of the data to primary drives 130.

FIG. 3 shows the timing of a data write process according to one particular embodiment. Storage controller 106 may receive a data write request for writing particular data 170.

At time T₁, data 170 may be sent to (a) cache memory 150 of one or more primary drives 130 and (b) one or more cache drives 160 for storage.

At time T₂, data 170 cached in cache memory 150 of primary drive(s) 130 may be written (i.e., flushed) to disk portion 152 of primary drives 130. T₂ may occur substantially immediately after T₁. Alternatively, data 170 may be stored in cache memory 150 for some time (e.g., until a triggering event), such that T₂ does not occur immediately after T₁.

At time T₃, data 170 cached in cache drive(s) 160 may be transferred to cache portion 152 of one or more secondary drives 132. This transfer from cache drive(s) 160 to secondary drive(s) 132 may occur after some triggering event, e.g., a predefined time period, the cache drive(s) 160 reaching a predefined fill level threshold, etc.

In some embodiments, controller 106 may synchronize data between cache drive(s) 160 and secondary drives 132 at step 326, e.g., using a map file, before transferring data from cache drive(s) 160 to secondary drives 132, in order to ensure the most recent data is saved on secondary drives 132.

At time T₄, data 170 cached in cache memory 150 of secondary drive(s) 132 may be written (i.e., flushed) to disk portion 152 of secondary drives 132. T₄ may occur substantially immediately after T₃. Alternatively, data 170 may be stored in cache memory 150 of secondary drive(s) 132 for some time (e.g., until a triggering event), such that T₄ does not occur immediately after T₃.

FIG. 4 illustrates an example method 200 of configuring an energy efficient mirrored RAID configuration for storage array 107, according to certain embodiments of the present disclosure.

According to one embodiment, method 200 preferably begins at step 202. Teachings of the present disclosure may be implemented in a variety of configurations of information handling system 100. As such, the preferred initialization point for method 200 and the order of the steps 202-208 comprising method 200 may depend on the implementation chosen.

At step 202, storage controller (e.g., RAID controller) 106 may determine whether mirroring is used for storage array 107. If not, the method may continue to step 204 for a traditional configuration of storage array 107.

However, if controller 106 determines that mirroring is used for storage array 107, the method may proceed to step 206. At step 206, controller 106 may assign one set of the mirrored disks in array 107 as the primary array 130 and the other set of the mirrored disks as the secondary array 132.

At step 208, controller 106 may control primary array 130 and secondary array 132, using any one or more of techniques (1)-(5) and/or other similar techniques for reducing the power consumption of array 107.

Method 200 may be implemented using information handling system 100 or any other system operable to implement method 200. In certain embodiments, method 200 may be implemented partially or fully in software embodied in tangible computer readable media, e.g., algorithms 116 stored in memory 104.

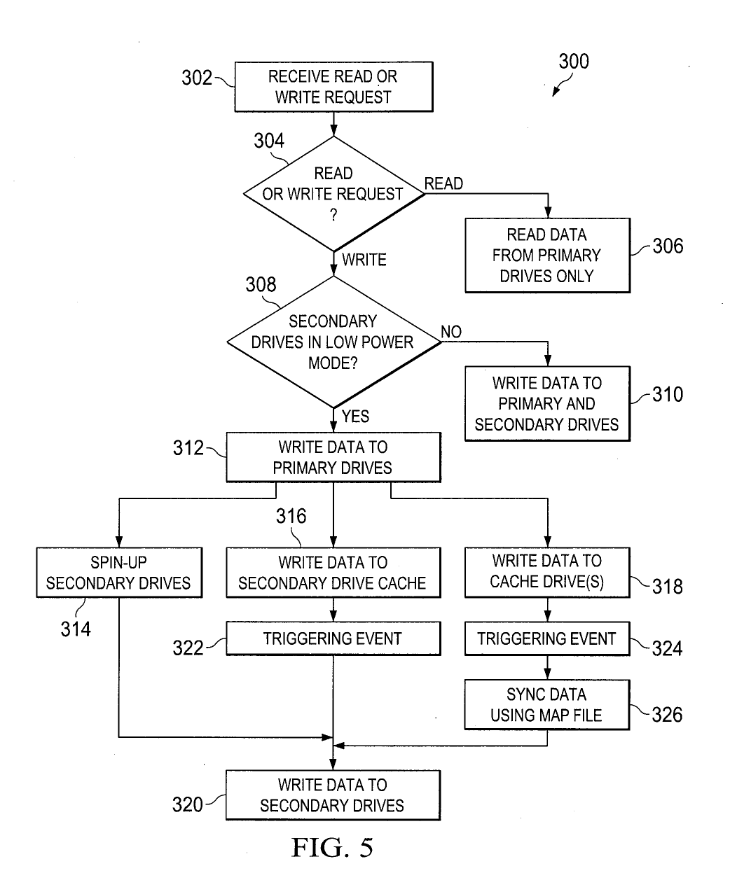

FIG. 5 illustrates an example method 300 of operating an energy efficient storage array 107, according to certain embodiments of the present disclosure.

According to one embodiment, method 300 preferably begins at step 302. Teachings of the present disclosure may be implemented in a variety of configurations of information handling system 100. As such, the preferred initialization point for method 300 and the order of the steps 302-308 comprising method 300 may depend on the implementation chosen.

At step 302, storage controller (e.g., RAID controller) 106 may receive a read or write request intended for storage array 107. At step 304, controller 106 may determine whether the request is a read request or a write request. If the request is a read request, at step 306 controller 106 may retrieve the requested data from primary drives 130 and not secondary drives 132, which may allow secondary drives 132 to be maintained in a lower power mode, which may conserve power.

Alternatively, if controller 106 determines at step 304 that the request is a write request, the method may proceed to step 308. At step 308, controller 106 may then determine whether secondary drives 132 are currently operating in a lower power mode (e.g., spun-down). If not, controller 106 may write the data to disk on both primary drives 130 and not secondary drives 132 at step 310.

However, if controller 106 determines at step 308 that secondary drives 132 are currently operating in a lower power mode (e.g., spun-down), controller 106 may then (a) write the data to disk on primary drives 130 at step 312, and (b) take one of the actions indicated at steps 314, 316, and 318, depending on the particular embodiment or situation.

Thus, in some embodiments or situations, controller 106 may (a) write the data to disk on primary drives 130 at step 312, and (b) spin-up secondary drives 132 at step 314. After spinning-up secondary drives 132, controller 106 may then write the data to secondary drives 132 at step 320.

In other embodiments or situations, controller 106 may (a) write the data to disk on primary drives 130 at step 312, and (b) store the data in cache 152 of secondary drives 132 at step 316. After some triggering event at step 322, the data in cache 152 may be written (i.e., flushed) to disk 150 on secondary drives 132 at step 320.

In other embodiments or situations, controller 106 may (a) write the data to disk on primary drives 130 at step 312, and (b) write the data to one or more cache drive(s) 160 at step 318. After some triggering event at step 324, controller 106 may synchronize data between cache drive(s) 160 and secondary drives 132 at step 326, e.g., using a map file. Controller 106 may then write the appropriate portions of data in cache drive(s) 160 to secondary drives 132 at step 320.

Method 300 may be implemented using information handling system 100 or any other system operable to implement method 300. In certain embodiments, method 300 may be implemented partially or fully in software embodied in tangible computer readable media, e.g., algorithms 116 stored in memory 104.

Although the present disclosure has been described in detail, it should be understood that various changes, substitutions, and alterations can be made hereto without departing from the spirit and the scope of the disclosure as defined by the appended claims.

What is claimed is:

1. A method for reducing power consumption in a mirrored disk array including first disk resources mirrored with second disk resources, the method comprising:
receiving a write request to write particular data to the mirrored disk array;
in response to receiving the write request:
spinning the first disk resources to write the particular data to the first disk resources; and
storing the particular data to a cache memory without spinning the second disk resources; and
subsequent to storing the particular data to the first disk resources and storing the particular data to the cache memory, spinning the second disk resources to write the particular data from the cache memory to the second disk resources.

2. A method according to claim 1, further comprising:
receiving a read request to read data from the mirrored disk array; and
in response to receiving the data write request:
spinning the first disk resources to read the data from the first disk resources; and
not spinning the second disk resources.

3. A method according to claim 1, wherein storing the particular data to a cache memory without spinning the second disk resources comprises storing the particular data to a cache memory portion of the second disk resources.

4. A method according to claim 1, wherein storing the particular data to a cache memory without spinning the second disk resources comprises storing the particular data to a cache memory separate from both the first disk resources and the second disk resources.

5. A method according to claim 1, wherein:
the mirrored disk array comprises a RAID 1 array;
the first disk resources comprise a single first disk; and
the second disk resources comprise a single second disk mirrored with the single first disk.

6. A method according to claim 1, wherein:
the mirrored disk array comprises a RAID 10 array;
the first disk resources comprise multiple first disks; and
the second disk resources comprise multiple second disks mirrored with the multiple first disks.

7. A method according to claim 1, wherein:
spinning the first disk resources to write the particular data to the first disk resources comprises spinning the first disk resources at a first speed; and
spinning the second disk resources to write the particular data from the cache memory to the second disk resources comprises spinning the first disk resources at a second speed slower than the first speed.

8. A method according to claim 1, further comprising:
determining whether the amount of data stored in the cache memory, including the particular data, has exceeded a predefined threshold level; and
wherein spinning the second disk resources to write the particular data from the cache memory to the second disk resources subsequent to storing the particular data to the cache memory comprises spinning the second disk resources to write the data stored in the cache memory, including the particular data, to the second disk resources in response to determining that the amount of data stored in the cache memory has exceeded the predefined threshold level.

9. A method according to claim 1, wherein spinning the second disk resources to write the particular data from the cache memory to the second disk resources subsequent to storing the particular data to the cache memory comprises spinning the second disk resources to write data stored in the cache memory, including the particular data, to the second disk resources after a predefined time interval.

10. An information handling system configured for reducing power consumption in a mirrored disk array, the information handling system comprising:
a mirrored disk array including first disk resources mirrored with second disk resources; and
a storage controller configured to:
receive a write request to write particular data to the mirrored disk array;
in response to receiving the write request:
spin the first disk resources to write the particular data to the first disk resources;
store the particular data to a cache memory without spinning the second disk resources; and
subsequent to storing the particular data to the first disk resources and storing the particular data to the cache memory, spin the second disk resources to write the particular data from the cache memory to the second disk resources.

11. A information handling system according to claim 10, wherein the storage controller is further configured to:
receive a read request to read data from the mirrored disk array; and
in response to receiving the data write request:
spin the first disk resources to read the data from the first disk resources; and
not spin the second disk resources.

12. A information handling system according to claim 10, wherein storing the particular data to a cache memory without spinning the second disk resources comprises storing the particular data to a cache memory portion of the second disk resources.

13. A information handling system according to claim 10, wherein storing the particular data to a cache memory without spinning the second disk resources comprises storing the particular data to a cache memory separate from both the first disk resources and the second disk resources.

14. A information handling system according to claim 10, wherein:
the mirrored disk array comprises a RAID 1 array;
the first disk resources comprise a single first disk; and
the second disk resources comprise a single second disk mirrored with the single first disk.

15. A information handling system according to claim 10, wherein:
the mirrored disk array comprises a RAID 10 array;
the first disk resources comprise multiple first disks; and
the second disk resources comprise multiple second disks mirrored with the multiple first disks.

16. A information handling system according to claim 10, wherein:
spinning the first disk resources to write the particular data to the first disk resources comprises spinning the first disk resources at a first speed; and
spinning the second disk resources to write the particular data from the cache memory to the second disk resources comprises spinning the first disk resources at a second speed slower than the first speed.

17. A information handling system according to claim 10, wherein:
the storage controller is further configured to determine whether the amount of data stored in the cache memory, including the particular data, has exceeded a predefined threshold level; and
spinning the second disk resources to write the particular data from the cache memory to the second disk resources subsequent to storing the particular data to the cache memory comprises spinning the second disk resources to write the data stored in the cache memory, including the particular data, to the second disk resources in response to determining that the amount of data stored in the cache memory has exceeded the predefined threshold level.

18. A information handling system according to claim 10, wherein spinning the second disk resources to write the particular data from the cache memory to the second disk resources subsequent to storing the particular data to the cache memory comprises spinning the second disk resources to write data stored in the cache memory, including the particular data, to the second disk resources after a predefined time interval.

19. A method for reducing power consumption in a mirrored disk array including first disk resources mirrored with second disk resources, the method comprising:
receiving a read or write request at the mirrored disk array;
in response to receiving the read or write request:
spinning the first disk resources to process the read or write request; and
not spinning the second disk resources during processing of the read or write request by the first disk resources.

20. A method according to claim 19, wherein:
the read or write request comprises a write request to write particular data to the mirrored disk array; and
the method comprises:
spinning the first disk resources to write the particular data to the first disk resources;
storing the particular data to a cache memory without spinning the second disk resources; and
subsequent to storing the particular data to the first disk resources and storing the particular data to the cache memory, spinning the second disk resources to write the particular data from the cache memory to the second disk resources.

21. A method according to claim 19, wherein:
the read or write request comprises a read request to read particular data from the mirrored disk array; and
the method comprises:
spinning the first disk resources to read the particular data from the first disk resources;
not spinning the second disk resources during the reading of the particular data from the first disk resources.
